(19) United States
(12) Patent Application Publication
(10) Pub. No.: US 2022/0171306 A1
(43) Pub. Date: Jun. 2, 2022

(54) LIQUID ELECTROPHOTOGRAPHIC INK COMPOSITION

(71) Applicant: Hewlett-Packard Development Company, L.P., Spring, TX (US)

(72) Inventors: Gregory Katz, Nes Ziona (IL); Ofir BROS, Nes Ziona (IL); Gleb ROMANTCOV, Nes Ziona (IL); Albert TEISHEV, Nes Ziona (IL); Emad MASOUD, Nes Ziona (IL); Yaron GRINWALD, Nes Ziona (IL)

(73) Assignee: Hewlett-Packard Development Company, L.P., Spring, TX (US)

(21) Appl. No.: 17/437,163

(22) PCT Filed: Jan. 29, 2020
(86) PCT No.: PCT/US2020/015526

§ 371 Date: Sep. 8, 2021

(51) Int. Cl. G03G 13/01; G03G 9/12; G03G 9/13; G03G 9/087; C09D 11/52; C09D 11/54; C09D 11/037

(52) U.S. Cl. CPC G03G 13/0131; G03G 9/122; G03G 9/13; C09D 11/037; C09D 11/52; C09D 11/54; G03G 9/08711

(57) ABSTRACT

A liquid electrophotographic ink composition is described. The liquid electrophotographic ink composition comprises a ceramic pigment, a polymer resin, a glass frit, and a liquid carrier. Also described is a heat transferable printed image, a process for printing a heat transferable image and a process for heat transfer printing using the liquid electrophotographic ink composition.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrophotographic image having image and background areas with different potentials. For example, an electrophotographic ink composition including charged particles in a liquid carrier can be brought into contact with the selectively charged photoconductive surface. The charged particles adhere to the image areas of the latent image while the background areas remain clean. The image is then transferred to a print substrate (e.g., a paper or polymer substrate) directly or by being first transferred to an intermediate transfer member, which can be a soft swelling blanket, which is often heated to fuse the solid image and evaporate the liquid carrier, and then to the print substrate. In some instances, the print substrate which receives the image from the electrophotographic printer is not the final substrate and instead serves as a transfer material from which the image can be released when in contact with the final substrate.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a”, “an”, and “the” include plural referents unless the context clearly dictates otherwise.

As used herein, “liquid carrier”, “carrier”, or “carrier vehicle” refer to the fluid in which the polymer resin, pigment(s), charge directors and/or other additives can be dispersed to form a liquid electrophotographic ink. Liquid carriers can include a mixture of a variety of different agents, such as surfactants, co-solvents, viscosity modifiers, humectants, sequestering agents, buffers, biocides and/or other possible ingredients.

As used herein, “electrophotographic ink composition” generally refers to an ink composition, which may be in liquid form, generally suitable for use in an electrophotographic printing process, sometimes termed an electrostatic printing process. The electrophotographic ink composition may include chargeable particles suspended in a liquid carrier, which may be as described herein. The electrophotographic ink composition may be referred to as an electrostatic ink composition.

As used herein, “co-polymer” refers to a polymer that is polymerized from at least two monomers. However, a copolymer of a particular list of monomer types (e.g., a copolymer of monomer A and monomer B) refers to a copolymer that is polymerized from monomers of those types and no other types of monomer (e.g. an AB polymer).

As used herein, “melt flow rate” generally refers to the extrusion rate of a resin through an orifice of defined dimensions at a specified temperature and load, usually reported as temperature/load, for example, 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrophotographic composition.

A certain monomer may be described herein as constituting a certain weight percentage of a polymer. This indicates that the repeating units formed from the said monomer in the polymer constitute said weight percentage of the polymer.

As used herein, “liquid electrostatic(ally) printing” or “liquid electrophotographic(ally) printing” generally refers to the process that provides an image that is transferred from a photo imaging substrate or plate either directly or indirectly via an intermediate transfer member to a print substrate, for example, a polymer substrate. As such, the image is not substantially absorbed into the photo imaging substrate or plate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field strength of 1000 V/cm or more, in some examples, 1000 V/mm or more.

As used herein, “LEP image” or “printed LEP image” refer to an image which has been printed, for example, on a print substrate, by liquid electrophotographically printing a LEP ink composition described herein.

As used herein, “ceramic pigment”, refers to particles of an inorganic, non-metallic, oxide, nitride or carbide material which are coloured or impart colour to a surface on which the pigment is applied. The particles of ceramic pigment, which may for example be metal oxide pigments, are suitable for forming images on ceramic and glass substrates. The ceramic metal oxide pigments may be prefired stain powders rather than raw colorants.

As used herein, “particle size”, or “particle diameter”, with particular reference to the D₅₀ particle size, refers to the volume equivalent sphere diameter of the particle that 50% of a sample's size is smaller than and 50% of a sample's size is larger than. Particle size as referred to herein may be measured using a laser diffraction particle size analyser, such as the Malvern Mastersizer.

As used herein, “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

If a standard test is mentioned herein, unless otherwise stated, the version of the test to be referred to is the most recent at the time of filing this patent application.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and subranges within the indicated range. Thus, included in this numerical range are individual values such as 2, 3.5, and 4 and sub-ranges such as from 1-3, from 2-4, and from 3-5, and so on. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect there is provided a liquid electrophotographic ink composition, comprising:
a ceramic pigment;
a polymer resin;
a glass frit; and
a liquid carrier.

In another aspect there is provided a heat transferable printed image, comprising:
a transfer material; and
an electrophotographic ink composition printed on the transfer material;
wherein the electrophotographic ink composition comprises:
   a ceramic pigment;
   a polymer resin; and
   a glass frit.

In another aspect there is provided a process for heat transfer printing, the process comprising:
electrophotographically printing a liquid electrophotographic ink composition onto a transfer material to form an image layer disposed on the transfer material, wherein the liquid electrophotographic ink composition comprises a ceramic pigment; polymer resin; a glass frit; and a liquid carrier, to form an image layer disposed on the transfer material;
contacting the image layer with a substrate under conditions such that the image layer transfers from the transfer material to the substrate; and
heating the substrate and the image layer to a temperature of at least 600° C.

The present inventors have found that examples of the processes and products as described herein provide for high resolution, vivid, and durable decoration of glass and ceramic substrates that can last as long as the substrate itself.

Liquid Electrophotographic Ink Composition

In some examples the liquid electrophotographic ink composition is a ceramic ink composition. The liquid electrophotographic ink composition may comprise a carrier liquid and chargeable particles suspended in the carrier liquid.

The chargeable particles may comprise a polymer resin, for example a thermoplastic polymer resin, and a ceramic pigment. The chargeable particles may comprise a polymer resin, for example a thermoplastic polymer resin, a ceramic pigment and a glass frit. In some examples, the liquid electrophotographic ink composition comprises a ceramic pigment; a polymer resin; a glass frit; and a liquid carrier.

In some examples, the electrophotographic ink composition may comprise a polymer resin, for example a thermoplastic resin, and a charge director. In some examples, the electrophotographic ink composition may comprise a polymer resin, for example a thermoplastic resin, the ceramic pigment, a glass frit and a charge director.

In some examples, the electrophotographic ink composition may comprise a polymer resin, for example a thermoplastic resin, and a charge adjuvant. In some examples, the electrophotographic ink composition may comprise a polymer resin, for example a thermoplastic resin, a ceramic pigment and a charge adjuvant. In some examples, the electrophotographic ink composition may comprise a polymer resin, for example a thermoplastic resin, a charge director and a charge adjuvant. In some examples, the electrophotographic ink composition may comprise a polymer resin, for example a thermoplastic resin, a ceramic pigment, a glass frit, a charge director and a charge adjuvant.

Liquid Carrier

In some examples, the electrophotographic ink composition comprises a liquid carrier. Generally, the liquid carrier can act as a dispersing medium for the other components in the electrophotographic ink composition. For example, the liquid carrier can comprise or be a hydrocarbon, silicone oil, vegetable oil, or the like. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples, below about 3. The liquid carrier can include, but is not limited to, hydrocarbons. The hydrocarbon can include, but is not limited to, an aliphatic hydrocarbon, an isomerized aliphatic hydrocarbon, a branched chain aliphatic hydrocarbon, an aromatic hydrocarbon, and combinations thereof. Examples of the liquid carrier include, but are not limited to, aliphatic hydrocarbons, isoparaffinic compounds, paraffinic compounds, dearomatized hydrocarbon compounds, and the like. In particular, the liquid carrier can include, but is not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™ Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before electrophotographic printing, the liquid carrier can constitute about 20% to 99.5% by weight of the electrophotographic ink composition, in some examples, 50% to 99.5% by weight of the electrophotographic ink composition. Before printing, the liquid carrier may constitute about 40 to 90% by weight of the electrophotographic ink composition. Before printing, the liquid carrier may constitute about 60% to 80% by weight of the electrophotographic ink composition. Before printing, the liquid carrier may constitute about 90% to 99.5% by weight of the electrophotographic ink composition, in some examples, 95% to 99% by weight of the electrophotographic ink composition.

The electrophotographic ink, when electrophotographic printed, may be substantially free from liquid carrier. In an electrophotographic printing process and/or afterwards, the liquid carrier may be removed, for example, by an electrophoresis processes during printing and/or evaporation, such that substantially just solids are transferred to the substrate. Substantially free from liquid carrier may indicate that the ink printed on the substrate contains less than 5 wt. % liquid carrier, in some examples, less than 2 wt. % liquid carrier, in some examples, less than 1 wt. % liquid carrier, in some examples, less than 0.5 wt. % liquid carrier. In some examples, the ink printed on the substrate is free from liquid carrier.

Resin

The electrophotographic ink composition includes a resin, which may be a thermoplastic resin. A thermoplastic polymer is sometimes referred to as a thermoplastic resin. The resin may coat the ceramic pigment(s). The resin may coat the glass frit(s). In some examples, the resin coats the ceramic pigment(s) such that particles are formed having a core of ceramic pigment and an outer layer of resin thereon. The outer layer of resin may coat the ceramic pigment(s) partially or completely. In some examples, the resin coats the frit(s) such that particles are formed having a core of frit and an outer layer of resin thereon. The outer layer of resin may coat the frit(s) partially or completely. In some examples, the resin coats the ceramic pigment(s) and frit such that particles are formed having a core of ceramic pigment and frit and an outer layer of resin thereon. The outer layer of resin may coat the ceramic pigment(s) and frit(s) partially or completely.

In some examples, the electrophotographic ink composition comprises ink particles comprising a ceramic pigment(s), a glass frit(s) and a resin.

The resin typically includes a polymer. In some examples, the polymer of the resin may be selected from ethylene acrylic acid copolymers; ethylene methacrylic acid copolymers; ethylene vinyl acetate copolymers; copolymers of ethylene (e.g. 80 wt % to 99.9 wt %) and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers:ethylene-acrylic esters-maleic anhydride (MAH) or glycidyl methacrylate (GMA) terpolymers; ethylene-acrylic acid ionomers and combinations thereof.

In some examples, the polymer is a copolymer of an alkylene monomer and a monomer having an acid side group. In some examples the alkylene monomer is an ethylene or a propylene monomer. In some examples, the monomer having an acid side group is an acrylic acid monomer or a methacrylic acid monomer. In some examples, the electrophotographic ink composition comprises a polymer resin comprising a copolymer of an alkylene monomer and a monomer selected from acrylic acid and methacrylic acid.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures, for example using the procedure described in ASTM D1386.

The resin may comprise a polymer, in some examples a polymer having acidic side groups, that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes.

In some examples, the polymer having acid side groups has a melt flow rate of greater than about 120 g/10 minutes, in some examples greater than about 200 g/10 minutes, in some examples greater than about 300 g/10 minutes, in some examples greater than about 400 g/10 minutes. In some examples, the polymer having acid side groups has a melt flow rate of about 450 g/10 minutes.

In some examples, the polymer having acid side groups has a melt flow rate of less than about 500 g/10 minutes.

In some examples, the polymer having acid side groups has a melt flow rate in the range of about 150 g/10 minutes to about 600 g/10 minutes. In some examples, the polymer having acid side groups has a melt flow rate in the range of about 200 g/10 minutes to about 500 g/10 minutes.

In some examples, the polymer having acid side groups constitutes at least 50 wt. % of the resin, in some examples at least 60 wt. % in some examples at least 80 wt. %, in some examples at least 90 wt. %. In some examples, the polymer having acid side groups has a melt flow rate of greater than about 200 g/10 minutes, in some examples a melt flow rate of greater than about 200 g/10 minutes and up to about 500 g/10 minutes, and constitutes at least 50 wt. % of the resin, in some examples at least 60 wt. % in some examples at least 80 wt. %, in some examples at least 90 wt. %.

The melt flow rate can be measured using standard procedures, for example as described in ASTM D1238.

The acidic side groups may be in free acid form or may be in the form of an anion and associated with one or more counterions, generally metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to about 25 wt % of the copolymer, in some examples from 10 wt % to about 20 wt % of the copolymer.

The resin may comprise two different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and an example of the second polymer is Nucrel 699 (from DuPont), and an example of the third polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin comprises a single type of resin polymer, the resin polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid or methacrylic acid, wherein the ethylenically unsaturated acid of either acrylic or methacrylic acid constitutes from about 8 wt % to about 16 wt % of the copolymer, in some examples about 10 wt % to about 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from about 12 wt % to about 30 wt % of the copolymer, in some examples from about 14 wt % to about 20 wt % of the copolymer, in some examples from about 16 wt % to about 20 wt % of the copolymer in some examples from about 17 wt % to about 19 wt % of the copolymer.

In some examples, the resin essentially consists of a copolymer of ethylene and methacrylic acid. In some examples the methacrylic acid of the copolymer of ethylene and methacrylic acid constitutes about 8 wt % to about 12 wt % of the copolymer, in some examples about 9 wt % to about 11 wt % of the copolymer, in some examples about 10 wt. % of the copolymer.

In an example, the resin constitutes about 5 to about 90%, in some examples about 5 to about 80%, by weight of the solids of the electrophotographic ink composition. In another example, the resin constitutes about 10 to about 60% by weight of the solids of the electrophotographic ink composition. In another example, the resin constitutes about 15 to about 40% by weight of the solids of the electrophotographic ink composition. In another example, the resin constitutes about 60 to about 95% by weight, in some examples from about 80 to about 90% by weight, of the solids of the electrophotographic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, for example, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute about 1 to about 50% by weight of the co-polymer, in some examples about 5 to about 40% by weight, in some examples 5 about to about 20% by weight of the copolymer, in some examples about 5 to about 15% by weight of the copolymer. The second monomer may constitute about 1 to about 50% by weight of the co-polymer, in some examples about 5 to about 40% by weight of the co-polymer, in some examples about 5 to about 20% by weight of the co-polymer, in some examples about 5 to about 15% by weight of the copolymer. In an example, the first monomer constitutes about 5 to about 40% by weight of the co-polymer, the second monomer constitutes about 5 to about 40% by weight of the co-polymer, and with the third monomer constituting the remaining weight of the copolymer. In an example, the first monomer constitutes about 5 to about 15% by weight of the co-polymer, the second monomer constitutes about 5 to about 15% by weight of the co-polymer, with the third monomer constituting the remaining weight of the copolymer. In an example, the first monomer constitutes about 8 to about 12% by weight of the co-polymer, the second monomer constitutes about 8 to about 12% by weight of the co-polymer, with the third monomer constituting the remaining weight of the copolymer. In an example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute about 1% or more by weight of the total amount of the resin polymers in the resin, e.g. the total amount of the polymer or polymers having acidic side groups and polymer having ester side groups. The polymer having ester side groups may constitute about 5% or more by weight of the total amount of the resin polymers in the resin, in some examples about 8% or more by weight of the total amount of the resin polymers in the resin, in some examples about 10% or more by weight of the total amount of the resin polymers in the resin, in some examples about 15% or more by weight of the total amount of the resin polymers in the resin, in some examples about 20% or more by weight of the total amount of the resin polymers in the resin, in some examples about 25% or more by weight of the total amount of the resin polymers in the resin, in some examples about 30% or more by weight of the total amount of the resin polymers in the resin, in some examples about 35% or more by weight of the total amount of the resin polymers in the resin. The polymer having ester side groups may constitute from about 5% to about 50% by weight of the total amount of the resin polymers in the resin, in some examples about 10% to about 40% by weight of the total amount of the resin polymers in the resin, in some examples about 15% to about 30% by weight of the total amount of the polymers in the resin.

The polymer having ester side groups may have an acidity of 50 mg KOH/g or more, in some examples an acidity of about 60 mg KOH/g or more, in some examples an acidity of about 70 mg KOH/g or more, in some examples an acidity of about 80 mg KOH/g or more. The polymer having ester side groups may have an acidity of about 100 mg KOH/g or less, in some examples about 90 mg KOH/g or less. The polymer having ester side groups may have an acidity of about 60 mg KOH/g to about 90 mg KOH/g, in some examples about 70 mg KOH/g to about 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of resins (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of resins (e.g. Aaclyn 201, Aclyn 246, Aclyn 285, and Aclyn 295), and the Lotader family of resins (e.g. Lotader 2210, Lotader, 3430, and Lotader 8200 (sold by Arkema)).

Ceramic Pigment

The liquid electrophotographic ink composition comprises a ceramic pigment. In some examples, the liquid electrophotographic ink composition comprises a plurality, for example two, three, four or five ceramic pigments. In some examples, each of the plurality of ceramic pigments imparts a different colour. In some examples, the ceramic pigment comprises particles of ceramic pigment. In some examples, the ceramic pigment comprises particles of ceramic pigment having a particle diameter (D₅₀) between 1.0 and 10 μm, for example between 2 and 9 μm, for example between 3 and 8 μm, for example between 4 and 7 μm, as measured using a Malvern Mastersizer.

In some examples, the ceramic pigment comprises particles of a metal oxide, a metal carbide or a metal nitride, or mixtures thereof. In some examples, the ceramic pigment comprises particles of a metal oxide or metal oxides. In some examples, the ceramic pigment comprises particles of a single metal oxide. In some examples, the ceramic pigment comprises particles of complex metal oxides, i.e. the oxide of multiple, different metals.

In some examples, the ceramic pigment may comprise a ceramic colorant selected from a black colorant, a magenta colorant, a yellow colorant and a cyan colorant. In some examples, the ceramic pigment comprises copper chromite (III), iron-manganese oxide, iron-chromium-manganese-nickel oxide, a cobalt compound, a zirconium compound, a titanium compound, a zinc compound, an aluminium compound, a copper compound, a tin compound, or a bismuth compound, or mixtures thereof. In some examples, the ceramic pigment comprises an oxide, carbide or nitride of antimony, calcium, copper, chromium, iron, manganese, nickel, cobalt, zirconium, titanium, zinc, vanadium, cadmium, selenium, aluminium, tin or bismuth, or mixtures thereof. In some examples, the ceramic pigment comprises copper chromite (III), an iron-manganese oxide, a zirconium-iron oxide, a cobalt-silicon oxide, a chromium-antimony-titanium oxide, a cobalt-chromium-iron-manganese oxide, an iron-chromium-manganese-nickel oxide, or a titanium oxide, or mixtures thereof.

In some examples, the ceramic pigment is present in the liquid electrophotographic ink composition in an amount of at least 5 wt % based on the total solids content of the ink. In some examples, the ceramic pigment is present in the liquid electrophotographic ink composition in an amount of at least 10 wt %, at least 20 wt %, at least 30 wt %, at least 40 wt %, at least 50 wt %, at least 60 wt %, at least 70 wt %, about 80 wt % based on the total solids content of the ink. In some examples, the ceramic pigment is present in the liquid electrophotographic ink composition in an amount of less than 80 wt %, less than 70 wt %, less than 60 wt %, less than 50 wt %, less than 40 wt %, less than 30 wt %, less than 20 wt %, or less than 10 wt %, about 5 wt % of the total solids content of the ink.

In some examples, the ceramic pigment is present in the liquid electrophotographic ink composition in an amount of from 5 wt % to 85 wt %, for example from 5 wt % to 75 wt %, for example from 5 wt % to 65 wt %, for example from 5 wt % to 55 wt, for example from 5 wt % to 45 wt % based on the total solids content of the ink.

Suitable ceramic pigments include those available from Glass Coatings & Concepts, LLC, part of The Shepherd Material Science Company. An example of a suitable yellow ceramic ink pigment is Yellow 30C236—CI Pigment Brown 24 (CAS #68186-90-3*; Chrome Antimony Titanium Buff Rutile); an example of a red ceramic pigment is Magenta 307 (CAS #SC-CB); an example of a blue ceramic pigment is PB0189, a cobalt-silicon compound; an example of a black ceramic pigment is PK0228, a cobalt-chromium-iron-manganese oxide; and an example of a white ceramic pigment is PW0319, R-900 rutile titanium dioxide.

Glass Frit

The liquid electrophotographic ink composition comprises a glass frit. In some examples, the glass frit comprises particles of glass. As used herein, the term “glass” is given its usual meaning in the art, and refers to any material that is non-crystalline and exhibits a glass transition when heated towards the liquid state. The glass frit may be any glass material capable of melting under conditions that do not adversely affect image quality in the processes described herein. The glass frit particles function as a glaze material intimately mixed with the ceramic ink pigment which together can be fired in an oven after transfer printing to render the final, durable surface decoration on the glass or ceramic substrate. Thus, in some examples, the glass frit is substantially colourless, or transparent, so as to not impart any colour to the final surface decoration. In some examples, the glass frit comprises particles of a silica-based material, for example a silicate glass. In some examples, the glass frit comprises particles of a borosilicate glass. In some examples, the glass frit comprises particles of a glass material comprising bismuth or zinc. In some examples, the glass frit comprises particles of a glass material comprising bismuth and zinc. In some examples, the glass frit comprises particles of a bismuth silicate, a bismuth titanate, titania, silica, and mixtures thereof.

In some examples, the glass frit comprises particles of a glass material having an average particle diameter (D₅₀) as determined using a Malvern Mastersizer of between 0.5 and 5 μm, for example between 1 and 4.5 μm, for example between 1.5 and 4 μm, for example between 2 and 3.5 μm, for example between 2.5 and 3 μm.

In some examples, the glass frit is present in the liquid electrophotographic ink composition in an amount of at least 1 wt % based on the total solids content of the ink. In some examples, the glass frit is present in the liquid electrophotographic ink composition in an amount of at least 10 wt %, at least 20 wt %, at least 30 wt %, at least 40 wt %, at least 50 wt %, at least 60 wt %, at least 70 wt %, at least 80 wt %, at least 90 wt %, about 95 wt %, based on the total solids content of the ink. In some examples, the glass frit is present in the liquid electrophotographic ink composition in an amount of less than 95 wt %, less than 90 wt %, less than 80 wt %, less than 70 wt %, less than 60 wt %, less than 50 wt %, less than 40 wt %, less than 30 wt %, less than 20 wt %, or less than 10 wt %, about 1 wt % of the total solids content of the ink.

In some examples, the glass frit is present in the liquid electrophotographic ink composition in an amount of from 1 wt % to 95 wt %, for example from 2 wt % to 90 wt %, for example from 5 wt % to 80 wt %, for example from 7 wt % to 70 wt %, for example from 10 wt % to 60 wt %, for example from 20 wt % to 50 wt %, for example from 30 wt % to 50 wt, for example from 40 wt % to 45 wt % based on the total solids content of the ink.

In some examples, the glass frit may have a softening point (e.g. as measured according to ASTM C338-93) of about 480° C. or greater, for example about 500° C. or greater, about 550° C. or greater, about 600° C. or greater, about 650° C. or greater, or about 700° C.

In some examples, the glass frit may have a softening point (e.g. as measured according to ASTM C338-93) of up to about 700° C., for example up to about 650° C., up to about 600° C., up to about 550° C., up to about 500° C., for example about 480° C.

In some examples, the glass frit may have a softening point (e.g. as measured according to ASTM C338-93) in the range of about 480° C. to about 700° C., for example about 500° C. to about 650° C., for example about 550° C. to about 600° C.

Charge Director

In some examples, the electrophotographic ink composition includes a charge director.

The charge director may be added in order to impart and/or maintain sufficient electrostatic charge on ink particles during electrophotographic printing, which may be chargeable particles comprising a thermoplastic resin comprising a copolymer of an alkylene monomer and an ethylenically unsaturated monomer comprising an epoxide. The charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, and the like. The charge director can be selected from, but is not limited to, oil-soluble petroleum sulfonates (e.g., neutral Calcium Petronate™, neutral Barium Petronate™, and basic Barium Petronate™), polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the chargeable particles of an electrophotographic ink composition.

In some examples, the electrophotographic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

The charge director may include at least one of (i) soya lecithin, (ii) a barium sulfonate salt, such as basic barium petronate (BBP), and (iii) an isopropyl amine sulfonate salt. Basic barium petronate is a barium sulfonate salt of a C21-26 hydrocarbon alkyl, and can be obtained, for example, from Chemtura. An example isopropyl amine sulfonate salt is dodecyl benzene sulfonic acid isopropyl amine, which is available from Croda.

In some examples, the electrophotographic ink composition comprises a charge director comprising a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I)

wherein each of R¹ and R² is an alkyl group.

The sulfosuccinate salt of the general formula MAₙ is an example of a micelle forming salt. The charge director may be substantially free of or free of an acid of the general formula HA, where A is as described above. The charge director may include micelles of said sulfosuccinate salt enclosing at least some of the nanoparticles. The charge director may include at least some nanoparticles having a size of 200 nm or less, and/or, in some examples, 2 nm or more.

In the formula [R¹—O—C(O)CH₂CH(SO₃⁻)C(O)—O—R²], in some examples, each of R¹ and R² is an aliphatic alkyl group. In some examples, each of R¹ and R² independently is a C3 to C30 alkyl, for example, C6-25 alkyl, C10 to C20 alkyl or C11 to C15 alkyl. In some examples, R¹ and R² are both C13 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same or different. In some examples, R¹ and R² are the same. In some examples, at least one of R¹ and R² is C₁₃H₂₇. In some examples, M is Na, K, Cs, Ca, or Ba.

In some examples, the charge director constitutes about 0.001 to 20% by weight, in some examples, 0.01 to 20% by weight, in some examples, 0.01 to 10% by weight, in some examples, 0.01 to 1% by weight of the solids of the electrophotographic ink composition. In some examples, the charge director constitutes about 0.001 to 0.15% by weight of the solids of the electrophotographic ink composition, in some examples, 0.001 to 0.15%, in some examples, 0.001 to 0.02% by weight of the solids of the electrophotographic ink composition, in some examples, 0.1 to 2% by weight of the solids of the electrophotographic ink composition, in some examples, 0.2 to 1.5% by weight of the solids of the electrophotographic ink composition, in some examples, 0.1 to 1% by weight of the solids of the electrophotographic ink composition, in some examples, 0.2 to 0.8% by weight of the solids of the electrophotographic ink composition. In some examples, the charge director is present in an amount of at least 1 mg of charge director per gram of the liquid electrostatic ink composition (which will be abbreviated to mg/g), in some examples, at least 2 mg/g, in some examples, at least 3 mg/g, in some examples, at least 4 mg/g, in some examples, at least 5 mg/g. In some examples, the charge director is present in an amount of from 1 mg to 50 mg of charge director per gram of the liquid electrophotographic ink composition (which will be abbreviated to mg/g), in some examples, from 1 mg/g to 25 mg/g, in some examples, from 1 mg/g to 20 mg/g, in some examples, from 1 mg/g to 15 mg/g, in some examples, from 1 mg/g to 10 mg/g, in some examples, from 3 mg/g to 20 mg/g, in some examples, from 3 mg/g to 15 mg/g, in some examples, from 5 mg/g to 10 mg/g.

In some examples, a sulfosuccinate salt based charge director may provide better charging stability than a charge director containing an amine (for example, the charge director comprising a mixture of soya lecithin, a barium sulfonate salt and an isopropyl amine sulfonate salt), thus prolonging the lifespan of the charged electrophotographic ink composition. In some examples, the charging stability is not affected by the presence of an amine in the charge director.

Charge Adjuvant

In some examples, the electrophotographic ink composition includes a charge adjuvant.

A charge adjuvant may promote charging of the chargeable particles when a charge director is present in the electrophotographic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminium di- or tristearate. The charge adjuvant may be present in an amount of about 0.1 to 5% by weight, in some examples, about 0.1 to 1% by weight, in some examples, about 0.3 to 0.8% by weight of the solids of the electrophotographic ink composition, in some examples, about 1 to 3% by weight of the solids of the electrophotographic ink composition, in some examples, about 1.5 to 2.5% by weight of the solids of the electrophotographic ink composition.

In some examples, the electrophotographic ink composition further includes, for example, as a charge adjuvant, a salt of a multivalent cation and a fatty acid anion. The salt of a multivalent cation and a fatty acid anion can act as a charge adjuvant. The multivalent cation may, in some examples, be a divalent or a trivalent cation. In some examples, the multivalent cation is selected from Group 2, transition metals, Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples, a C14 to C22 fatty acid anion, in some examples, a C16 to C20 fatty acid anion, in some examples, a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the solids of the electrophotographic ink composition, in some examples, in an amount of 0.1 wt. % to 2 wt. % of the solids of the electrophotographic ink composition, in some examples, in an amount of 0.1 wt. % to 2 wt. % of the solids of the electrophotographic ink composition, in some examples, in an amount of 0.3 wt. % to 1.5 wt. % of the solids of the electrophotographic ink composition, in some examples, about 0.5 wt. % to 1.2 wt. % of the solids of the electrostatic ink composition, in some examples, about 0.8 wt. % to 1 wt. % of the solids of the electrophotographic ink composition, in some examples, about 1 wt. % to 3 wt. % of the solids of the electrophotographic ink composition, in some examples, about 1.5 wt. % to 2.5 wt. % of the solids of the electrophotographic ink composition.

Additives

The ceramic electrophotographic ink composition may include an additive or a plurality of additives. The additive or plurality of additives may be added at any stage of the method of producing the ink composition. The additive or plurality of additives may be selected from a wax, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, for example, from an intermediate transfer member, which may be a heated blanket.

Method of Producing the Liquid Electrophotographic Ink Composition

Also provided is a method of producing a liquid electrophotographic ink composition as described herein. The method may comprise:
combining a resin, a ceramic pigment, a glass frit and a liquid carrier.

The method of combining the resin, ceramic pigment, glass frit and liquid carrier may be any method typically used to prepare liquid electrophotographic ink compositions. For example, the method may comprise preparing chargeable particles by combining resin, ceramic pigment and glass frit in the presence of liquid carrier, under conditions that result in at least partial encapsulation of the ceramic pigment and/or glass frit by the resin, thereby producing the chargeable particles. In some examples, the method may comprise preparing the liquid electrophotographic ink composition by combining resin, ceramic pigment and glass frit in the presence of liquid carrier, under conditions that result in at least partial encapsulation of the ceramic pigment and/or glass frit by the resin, thereby producing the liquid electrophotographic ink composition. In some examples, the method comprises forming ink particles comprising the resin, the pigment, and the glass frit, and dispersing the ink particles in the carrier liquid to form the liquid electrophotographic ink composition.

In some examples, forming the ink particles comprises grinding the resin, pigment(s) and glass frit(s) in the presence of a carrier liquid. In some examples, the resin, pigment(s) and glass frit(s) are ground in the present of a carrier liquid and a charge adjuvant such as VCA. In some examples, additional carrier liquid may then be added to the composition. In some examples, the method comprises adding a charge director to the composition comprising ink particles dispersed in a carrier liquid.

In some examples, grinding the resin, pigment(s) and glass frit(s) in the presence of a carrier liquid comprises grinding at a non-volatile solids content (based on the total weight of the composition being ground) of at least 20 wt %, for example at least 30 wt %, for example 50 wt %. In some examples, grinding the resin, pigment(s) and glass frit(s) in the presence of a carrier liquid comprises grinding for at least one hour, for example at least 1.5 hours, for example at least 3 hours or until such a time as a desired particle size is obtained. In some examples, grinding the resin, pigment(s) and glass frit(s) in the presence of a carrier liquid comprises grinding at a temperature of from 40° C. to 45° C.

In some examples, grinding the resin, pigment(s) and glass frit(s) in the presence of a carrier liquid comprises grinding until a desired particle size is obtained. In some examples, grinding the resin, pigment(s) and glass frit(s) in the presence of a carrier liquid comprises grinding until the particles have an average diameter (D₅₀) as determined using a Malvern Mastersizer of between 0.5 and 20 μm, for example between 1 and 18 μm, for example between 2 and 16 μm, for example between 3 and 14 μm, for example between 4 and 12 μm, for example about 10 μm. In some examples, the ground ink particles have an average diameter (D₅₀) of between 0.5 and 10 μm.

Grinding of pigments with resins to produce ink particles can be performed using any commercial grinding equipment, for example attritors such as the S0 attritor from Union Process. The grinding may be carried out using a metallic grinding media, or a non-metallic grinding media. The grinding media may be or comprise carbon steel, or chrome steel, or stainless steel, or steel shot. The grinding media may be or comprise alumina or other ceramic material such as glass mullite silicon carbide silicon nitride, tungsten carbide zirconium oxide, or zirconium silicate. The grinding media may be or comprise spherical or substantially spherical media, satellites or radius-end cylinders. Satellites will be understood as being substantially spherical with a protruding band around the circumference. The grinding media may be 35 mm or less in diameter, 31 mm or less in diameter, 30 mm or less in diameter, for example 26 mm or less, 25 mm or less, 15 mm or less, 12.7 mm or less in diameter, 10 mm or less, for example 9.5 mm or less, 7.9 mm or less, 5.6 mm or less, 6.4 mm or less, 3.9 mm or less, 3.2 mm or less, 2.4 mm or less, 2 mm or less, for example 1.7 mm or less, 1.4 mm or less, 1 mm or less, 1.18 mm or less, 0.7 mm or less, 0.6 mm or less, 0.5 mm or less, 0.4 mm or less, or 0.25 mm or less in diameter.

Ink Set

In some examples of the disclosure, there is described an ink set, comprising a plurality of ink compositions as described herein. In some examples, each ink composition of the plurality of ink compositions comprises a ceramic pigment imparting a cyan, magenta, yellow, black or white colour, as with other liquid electrophotographic ink compositions. In some examples, the ink set comprises a plurality of ink compositions selected from (i) an ink composition comprising a yellow ceramic pigment; (ii) an ink composition comprising a cyan ceramic pigment; (iii) an ink composition comprising a magenta ceramic pigment; (iv) an ink composition comprising a black ceramic pigment; (v) an ink composition comprising a white ceramic pigment. Other ink compositions comprising specialist pigments may also be comprised within the ink set.

Heat Transferable Printed Image

In some examples of the disclosure, there is described a heat transferable printed image, comprising:
a transfer material; and
an electrophotographic ink composition disposed on the transfer material;
   wherein the electrophotographic ink composition is as described previously.

Transfer Material

The transfer material may be a material which conducts heat and on which the transparent release composition can be electrophotographically printed. The image layer is printed on the transfer material in reverse of how the image is to appear on the glass or ceramic substrate. The transfer material may also be referred to as the “label sheet” or the “ribbon”. The transfer material may be a material that is different from the glass or ceramic substrate. For example, the transfer material may be a polymer film or a paper substrate.

In some examples, the transfer material comprises a polymer film. The polymer film may comprise a film of any thermoplastic material. The thermoplastic film may comprise a film of any thermoplastic material with a softening temperature and/or melting temperature below the softening temperature of the image layer. The thermoplastic film may comprise a film of any thermoplastic material with a softening temperature and/or melting temperature below the melting temperature of the image layer.

In some examples, the transfer material is to allow good thermal transfer. In some examples, the transfer material comprises a film of material, wherein the film is less than 100 μm in thickness, for example less than 90 μm in thickness, less than 80 μm in thickness, less than 70 μm in thickness, less than 60 μm in thickness, less than 50 μm in thickness, less than 40 μm in thickness, less than 30 μm in thickness, less than 20 μm in thickness, less than 15 μm in thickness. The transfer material may be in the form of a sheet or film and/or may have a thickness of from 5 μm to 250 μm, in some examples from 5 μm to 100 μm, in some examples from 5 μm to 50 μm, in some examples 5 to 20 μm or in some examples from 100 μm to 250 μm.

The transfer material may comprise a plurality of layers, e.g. a layer comprising a material selected from a polyester film (such as a polyethylene terephthalate (PET) film), a polyvinyl chloride (PVC) film and a polyethylene film, and a further layer, which may be a primer layer, onto which the transparent release composition is printed.

The transfer material may include a material selected from an organic or inorganic material. The material may include a natural polymeric material, e.g. cellulose. The material may include a synthetic polymeric material, e.g. a polymer formed from alkylene monomers, including, but not limited to, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), and mixtures thereof. In an example, the transfer material includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The transfer material is, in some examples, a cellulosic print medium such as paper. The cellulosic print medium is, in some examples, a coated cellulosic print medium.

In one example, the transfer material comprises a film or sheet of at least one of paper, metallic foil, and plastic. In one example, the transfer material is transparent. In one example, the transfer material comprises a metallized paper or a metallized plastic film. In one example, the transfer material comprises an aluminium foil. In one example the transfer material comprises a film of a plastic material, for example, polyethylene (PE), linear low density polyethylene (LLDPE), low density polyethylene (LDPE), polypropylene (PP), biaxially oriented polypropylene (BOPP). In one example, the transfer material comprises a metallized paper in the form of a paper substrate coated on one surface with a layer of metal, for example aluminium. In one example, the transfer material comprises a metallized plastic film in the form of a polymer substrate coated on one surface with a layer of metal, for example aluminium. In one example, the transfer material comprises a metallized plastic film in the form of a metallized BOPP film, a metallized PET film, or a metallized polyethylene (PE) film.

In some examples, the transfer material is subjected to a corona treatment prior to printing the transparent release composition, which may also improve bond strength of the transparent release composition to the transfer material.

Primer/Release Composition

In some examples, the transfer material comprises a layer of primer or release composition disposed on a surface thereof.

In some examples, the primer or transparent release composition comprises a thermoplastic resin, and a solid polar compound. In some examples, the primer or transparent release composition comprises a charge adjuvant and/or a charge director. The thermoplastic resin, charge adjuvant and charge director may be as described previously in connection with the ceramic ink compositions.

The thermoplastic resin of the primer composition or release layer may be softened to allow transfer of the heat transferable image from the transfer material to a target substrate.

In some examples, the thermoplastic resin may have a softening point (e.g. Vicat softening point as measured according to ASTM D1525 or the Ring and Ball softening point as determined according to ASTM E28-99) of about 30° C. or greater, for example about 40° C. or greater, about 50° C. or greater, or about 60° C. or greater.

In some examples, the thermoplastic resin may have a softening point (e.g. Vicat softening point as measured according to ASTM D1525 or the Ring and Ball softening point as determined according to ASTM E28-99) of up to about 150° C., for example up to about 130° C., up to about 120° C., up to about 110° C., or up to about 100° C.

In some examples, the thermoplastic resin may have a softening point (e.g. Vicat softening point as measured according to ASTM D1525 or the Ring and Ball softening point as determined according to ASTM E28-99) in the range of about 60° C. to about 150° C., for example about 60° C. to about 110° C.

The primer or transparent release composition does not contain any pigment, or substantially lacks pigment and thus is a pigment-free, or substantially pigment-free composition. The primer or transparent release composition may otherwise be termed a transparent or colourless electrophotographic ink composition or a colorless varnish for digital printing. The primer or transparent release composition may comprise less than 5 wt. % solids of colorant, in some examples less than 3 wt. % solids of colorant, in some examples less than 1 wt. % solids of colorant, in some examples less than 0.5 wt. % solids of colorant, in some examples less than 0.1 wt. % solids of colorant. A “colorant” may be a material that imparts a color to the composition.

The thermoplastic resin may constitute at least 85 wt. % of the solids of the primer composition, in some examples at least 90 wt. % of the solids of the primer composition, in some examples 95 wt. % of the solids of the primer composition.

If a solid polar compound is present, the thermoplastic resin and the solid polar compound together may constitute at least 85 wt. % of the solids of the primer composition, in some examples at least 90 wt. % of the solids of the primer composition, in some examples 95 wt. % of the solids of the primer composition.

The primer composition may further comprise one or more additives such as surfactants, viscosity modifiers, emulsifiers and the like.

In some examples, once printed, the primer composition forms a release layer of less than 10 μm in thickness, for example less than 9 μm in thickness, less than 8 μm in thickness, less than 7 μm in thickness, less than 6 μm in thickness, less than 5 μm in thickness, less than 4 μm in thickness, less than 3 μm in thickness, less than 2 μm in thickness, less than 1.5 μm in thickness. In some examples, the primer composition forms a release layer having a thickness of about 1 μm.

In some examples, once printed, the primer composition forms a release layer having a thickness of greater than 0.1 μm, for example greater than 0.2 μm, greater than 0.3 μm, greater than 0.4 μm, greater than 0.5 μm, greater than 0.6 μm, greater than 0.7 μm, greater than 0.8 μm, greater than 0.9 μm.

In some examples, once printed, the primer composition forms a release layer having a thickness of 0.1 μm to 10 μm, for example, 0.2 μm to 9 μm, 0.3 μm to 8 μm, 0.4 μm to 7 μm, 0.5 μm to 6 μm, 0.6 μm to 5 μm, 0.7 μm to 4 μm, 0.8 μm to 3 μm, 0.9 to 2 μm, 0.1 μm to 1.5 μm.

The primer or transparent release composition may further comprise a solid polar compound. The solid polar compound contains polar atoms, such as oxygen, nitrogen, etc., that prevent the solid compounds from dissolving or even swelling in a non-polar carrier liquid. As such, the solid polar compounds do not interact with the non-polar carrier liquid, but rather are dispersed in the thermoplastic resin. In some examples, the solid polar compound is a solid (e.g., at room temperature, i.e., from about 20° C. to about 25° C.), colorless organic material. The solid organic material may be a polymeric material or a non-polymeric material. The solid polar compound may be an organic particle that is resistant to swelling or dissolving in a non-polar carrier fluid, e.g. an isoparaffinic fluid as described herein. The solid polar compound may be dispersed in the thermoplastic resin, and, in some examples, is present in an amount up to 60 wt. % of solids in the transparent release composition. The solid polar compound may be selected from the group consisting of a saccharide, polyacrylic acid, polyvinyl alcohol, styrene maleic anhydride, a bismaleimide oligomer, a cellulose derivative and an aliphatic urethane acrylate.

In some examples, the transparent release composition comprises a saccharide. In some examples, the saccharide may be a modified saccharide. In some examples, modified saccharides are acetylated saccharides. In some examples, the transparent release composition comprises a disaccharide, e.g. a modified disaccharide. In some examples, the transparent release composition comprises a saccharide, e.g. a modified saccharide. In some examples, the saccharide may be selected from maltose, maltose monohydrate, sucrose, sucrose octanoate, sucrose octaacetate, dextrin, xylitol and sucrose benzoate.

In some examples, the transparent release composition comprises a saccharide in an amount of greater than 15 wt. % of the non-volatile solids in the transparent release composition, for example, in an amount of greater than 20 wt. % of the non-volatile solids in the transparent release composition, for example in an amount of greater than 25 wt. % of the non-volatile solids in the transparent release composition, for example in an amount of greater than 30 wt. % of the non-volatile solids in the transparent release composition. In some examples, the transparent release composition comprises a saccharide in an amount of less than 60 wt. % of the non-volatile solids in the transparent release composition, for example less than 50 wt. % of the non-volatile solids in the transparent release composition, for example less than 45 wt. % of the non-volatile solids in the transparent release composition, for example less than 40 wt. % of the non-volatile solids in the transparent release composition.

In some examples, the solid polar compound has a particle size from about 30 nm to about 300 nm, for example from about 50 nm to about 150 nm, or from about 70 nm to about 130 nm. The particle size of the solid polar compound may be the average particle size as determined by SEM, for example the average particle size of 100 particles as determined using SEM. In some examples, the particle size may be the average particle size determined using a Malvern particle size analyser.

Examples of commercially available styrene maleic anhydrides include copolymers from Sartomer Co. USA, LLC, such as SMA® 40001, SMA® 10001, and SMA® 1000P.

Examples of cellulose derivatives include sodium carboxylmethyl cellulose and cellulose acetate propionate. A suitable example of a bismaleimide oligomer is bis-stearamide, and a suitable example of an aliphatic urethane acrylate is REAFREE® UV ND-2335 from Arkema, Spain.

It is to be understood that these solid polar compounds are examples, and that any other organic material that includes polar atoms and is resistant to swelling or dissolving in a non-polar carrier fluid may be used.

Other Additives

The transparent release composition may include an additive or a plurality of additives as described above in connection with the ceramic ink composition.

Image Layer

In some examples, the electrophotographic ink composition disposed on the transfer material forms an image layer. In some examples, the primer or transparent release composition on the transfer material has printed thereon an electrophotographic ink composition which may form an image or information, which may therefore be said to form an image layer. The image layer may comprise a ceramic colorant or a plurality of ceramic colorants as described above. The image layer may comprise a ceramic colorant selected from a black colorant, a magenta colorant, a yellow colorant and a cyan colorant, or a combination thereof as described above.

In some examples, the image or image layer is printed on the transparent release composition on the transfer material in an electrophotographic printing process as described herein.

The image or information may be mirror printed onto the transfer material such that the image transferred to the target substrate appears as the image input in a digital printing process. In some examples, the image or information may be printed to the transfer material such that the image when viewed on the transfer material appears as the image input in a digital printing process, for example in cases in which the target substrate is transparent, e.g. glass, and the image is to be viewed through the target substrate.

Process for Printing a Heat Transferable Image

In some examples of the disclosure there is provided a process for printing a heat transferable image, the process comprising:
electrophotographically printing a liquid electrophotographic ink composition onto a transfer material to form an image layer disposed on the transfer material; wherein
the liquid electrophotographic ink composition is as described previously.

In some examples, the transfer material is as described herein.

In some examples, the process comprises electrophotographically printing a liquid electrophotographic ink composition onto a primer layer disposed on the transfer material to form an image layer disposed on the primer layer.

In some examples, the primer layer is pre-printed onto the transfer material as part of a separate process. In some examples, the process comprises electrophotographically printing a liquid electrophotographic primer composition onto a transfer material; and electrophotographically printing a liquid electrophotographic ink composition onto the primer material.

In some examples, the primer composition is as described herein and is also referred to as a release composition or release layer. The primer composition serves to modify the surface of the transfer material so as to allow transfer of an image layer from the transfer material to the substrate.

In some examples, the image layer is as described herein.

The printing of the image layer may be carried out using an electrostatic or electrophotographic printing process, e.g. using the same electrophotographic printing apparatus used to print the primer on the transfer material. The electrophotographic printing of the image layer may involve
forming a further latent electrophotographic image on a surface;
contacting the surface with an electrophotographic ink composition as described herein, such that at least some of the ink composition adheres to the surface to form a developed toner image on the surface, and transferring the toner image to the primer composition (e.g. release layer) on the transfer material, in some examples via an intermediate transfer member.

The electrophotographic printing of the primer composition and the overlying image layer on the transfer material may be carried out in a single pass, e.g. by printing the primer composition and the image together onto the transfer material, e.g. such that the image layer overlies the primer composition on the transfer material. In some examples, this may involve disposing an image layer (formed with an electrophotographic ink composition comprising a ceramic pigment) first on an intermediate transfer member in an electrophotographic printing process and then forming an overlying layer of primer composition on the image layer, and transferring the image layer and the primer layer to the transfer material.

The surface on which the latent electrostatic image is formed may be on a rotating member, e.g. in the form of a cylinder. The surface on which the latent electrostatic image is formed may form part of a photo imaging plate (PIP). The contacting may involve passing the primer composition between a stationary electrode and a rotating member, which may be a member having the surface having a latent electrostatic image thereon or a member in contact with the surface having a latent electrostatic image thereon. A voltage is applied between the stationary electrode and the rotating member, such that the particles adhere to the surface of the rotating member. This may involve subjecting the transparent release composition to an electric field having a field gradient of 50-400V/μm, or more, in some examples 600-900V/μm, or more.

The intermediate transfer member may be a rotating flexible member, which is in some examples heated, e.g. to a temperature of from 80° C. to 160° C., in some examples from 90° C. to 130° C., in some examples from 100° C. to 110° C.

Process for Heat Transfer Printing

In some examples of the disclosure there is provided a process for heat transfer printing, the process comprising:
electrophotographically printing a liquid electrophotographic ink composition onto a transfer material to form an image layer disposed on the transfer material, wherein the liquid electrophotographic ink composition is as described herein, to form an image layer disposed on the transfer material;
contacting the image layer with a substrate under conditions such that the image layer transfers from the transfer material to the substrate; and
heating the substrate and the image layer to a temperature of at least 600° C.

In some examples, the substrate is a glass or ceramic substrate.

In some examples, electrophotographically printing a liquid electrophotographic ink composition onto a transfer material comprises electrophotographically printing a liquid electrophotographic ink composition onto a primer layer disposed on the transfer material. The primer layer may be as described herein.

In some examples, the electrophotographic printing may be as described above. In some examples, the image layer formed on the transfer material may be as described above.

In some examples, contacting the image layer with a substrate comprises laminating the image layer to the substrate. In some examples, contacting the image layer with a substrate comprises placing the image layer in contact with the substrate.

In some examples, laminating the image layer to a substrate comprises applying heat to the transfer material when the image layer is in contact with the substrate. In some examples, laminating the image layer to a substrate comprises applying pressure to the transfer material when the image layer is in contact with the substrate. In some examples, laminating the image layer to a substrate comprises applying heat and pressure to the transfer material when the image layer is in contact with the substrate.

In some examples, laminating the image layer to a substrate is carried out at a suitable temperature to adhere the image layer to the substrate, which may be a suitable temperature to allow the image layer (e.g., the thermoplastic resin in the image layer), if present the primer layer in contact with the image layer, or both to soften or become molten. In some examples, laminating the image layer to a substrate is carried out at a suitable temperature to soften or melt the image layer (e.g., the thermoplastic resin in the image layer). Although the image layer may be heated to a temperature at which it softens or melts, the intensity and duration of heating means that image quality is not affected. The suitable temperature may be a raised temperature, for example, of 30° C. or above, in some examples, 40° C. or above, 50° C. or above, 60° C. or above, 70° C. or above, 80° C. or above, 90° C. or above, 100° C. or above, 110° C. or above, 120° C. or above, 130° C. or above, 140° C. or above, 150° C. or above, or 180° C. or above. The suitable temperature may be from 30° C. to 100° C., in some examples 30° C. to 90° C., in some examples 30° C. to 70° C., in some examples 40° C. to 80° C. The suitable temperature may be from 50° C. to 250° C., in some examples from 60° C. to 220° C., in some examples from 90° C. to 210° C., in some examples from 90° C. to 130° C., in some examples from 100° C. to 110° C.

The suitable temperature may be a temperature at or above the Vicat softening point of the primer layer, the image layer (e.g., the thermoplastic resin in the image layer), or both, as measured using ASTM D1525. The suitable temperature may be a temperature at or above the freezing point of the primer layer, the image layer (e.g., the thermoplastic resin in the image layer), or both, as measured by Differential Scanning Calorimetry under ASTM D3418. The suitable temperature may be a temperature at or above the melting point of the primer layer, the image layer (e.g., the thermoplastic resin in the image layer), or both, as measured by Differential Scanning Calorimetry under ASTM D3418. Where a plurality of polymers are used in the primer layer, the image layer, or both, the softening point, the freezing point or the melting point, may be measured on the blend of polymers.

In some examples, the image layer adheres to the target substrate when the thermoplastic polymer of the image layer is softened. In some examples, the image layer adheres to the target substrate when the thermoplastic polymer of the image layer is melted.

In some examples, the image layer may adhere to the target substrate while the thermoplastic resin of the image layer is softened or molten. In some examples, the target substrate and the transfer material may be separated while the image layer and the release layer (e.g., the thermoplastic resin in the release layer) are softened or molten.

In some examples, laminating the image layer with the substrate may involve pressing the heat transferable printed image and the substrate between two members, at least one of which, in some examples, both of which, is/are heated, for example, to a temperature mentioned above in order to transfer the image layer from the transfer material to the substrate. In some examples, contacting the image layer with the substrate may involve pressing the transfer material and the target substrate between two members, at least one of which, in some examples, both of which, is/are heated, for example, to a temperature mentioned above. In some examples, contacting the image layer with the substrate may involve pressing the transfer material and the target substrate between two members, in which the member in contact with the transfer material is heated, for example, to a temperature mentioned above. In some examples, the heating is to a temperature of 100° C. to 200° C., for example, 130° C. to 170° C., for example 140° C. to 160° C., for example about 150° C.

The two members may independently be rollers or belts and may be part of a lamination apparatus. In some examples, the member in contact with the transfer material is a roller, and the substrate is supported by a surface. The surface may or may not be a conveyor belt. In some examples, the speed of passing the target substrate and the transfer material (having the transparent primer layer and image layer thereon) via a roller to the substrate may be any suitable speed to allow the image layer and/or primer layer to soften or melt and adhere to the target substrate. The speed may be at least 0.1 m/min, in some examples at least 0.5 m/min, in some examples at least 1 m/min. The speed may be at least 10 m/min or less, in some examples 5 m/min or less, in some examples 4 m/min or less, in some examples 3 m/min or less, in some examples, 2 m/min or less. The speed may be of from 0.1 m/min to 10 m/min, in some examples from 0.5 m/min to 5 m/min, in some examples 0.5 m/min to 4 m/min, in some examples 1 m/min to 3 m/min, in some examples, 0.1 m/min to 1 m/min. The speed may be determined depending on the temperature of the roller, with a higher temperature leading to faster softening/melting of the image layer and/or primer layer (e.g., the thermoplastic resin of the image and/or primer layers) and/or faster adhesion of the image layer to the target substrate, allowing for a higher speed, since the contact time can be less.

Pressure may be applied during the lamination of the image layer to the substrate. Pressure may be applied during the contacting of the image layer with the target substrate. The pressure may be a pressure of at least from 1 bar (100 kPa), in some examples at least 2 bar, in some examples from 1 bar to 20 bar, in some examples 2 bar to 10 bar, in some examples 2 bar to 5 bar, in some examples 5 bar to 10 bar.

The contacting under a raised temperature and, in some examples, under pressure, may be carried out for a suitable time period to effect adhesion and to soften the image layer and/or the release layer, and the suitable time period may be at least 0.1 seconds, in some examples at least 0.2 seconds, in some examples at least 0.5 seconds, in some examples at least 0.8 seconds, in some examples at least 1 second, in some examples at least 1.2 seconds, in some examples at least 1.5 seconds, in some examples at least 1.8 seconds, in some examples at least 2 seconds.

The suitable time period may be from 0.1 seconds to 100 seconds, in some examples, 0.1 seconds to 90 seconds, in some examples, 0.2 seconds to 80 seconds, in some examples, 0.5 seconds to 70 seconds, in some examples, 0.8 seconds to 60 seconds, in some examples, 1 second to 50 seconds, in some examples, 1.2 seconds to 40 seconds, in some examples, 1.5 seconds to 30 seconds, in some examples, 1.8 seconds to 20 seconds, in some examples, 2 seconds to 10 seconds, in some examples 0.5 seconds to 5 seconds.

In some examples, the substrate and the image layer are heated to a temperature of at least 600° C. In some examples, the substrate with the image layer disposed thereon is heated to a temperature of at least 600° C. The heating step is a firing step, and is to fuse or weld the image layer to the glass or ceramic substrate by softening or melting the ceramic pigment and/or the glass frit sufficiently to fuse the image to the substrate.

In some examples, the substrate and the image layer are heated to a temperature of at least 600° C., at least 700° C., at least 800° C., at least 900° C., at least 1000° C., at least 1100° C., at least 1200° C., for example 1250° C. In some examples, the substrate and the image layer are heated to a temperature of less than 1250° C., less than 1150° C., less than 1050° C., less than 950° C., less than 850° C., less than 750° C., or less than 650° C., for example about 600° C. In some examples, the substrate and the image layer are heated to a temperature of from 600° C. to 1250° C., from 700° C. to 1150° C., from 800° C. to 1050° C., from 900° C. to 950° C.

In some examples, the substrate and the image layer are heated to a temperature as described herein for a time period from at least 15 minutes, at least 30 minutes, at least 45 minutes, at least 60 minutes, or at least 100 minutes, or at least 120 minutes, or at least 180 minutes, or at least 210 minutes, for example 240 minutes. The duration of heating may be dependent on the temperature to which the substrate with the image layer thereon is being heated.

In some examples of the disclosure there is provided a product obtainable by the process for heat transfer printing described herein. In some examples of the disclosure there is provided a glass or ceramic substrate comprising a surface decoration obtainable by the process for heat transfer printing described herein.

In some examples of the disclosure there is provided a product, for example a glass or ceramic substrate comprising a ceramic ink surface decoration wherein the ceramic ink is as described herein. In some examples of the disclosure there is provided a product, for example a glass or ceramic substrate comprising an image layer of ceramic ink as described herein.

### EXAMPLES

The following illustrates examples of the compositions and related aspects described herein. Thus, these examples should not be considered to restrict the present disclosure, but are merely in place to teach how to make examples of compositions of the present disclosure.

Materials

Resins:

AC-5120 (available from Honeywell): an ethylene-acrylic acid copolymer with nominally 15 wt % acrylic acid.

Nucrel 699™: a copolymer of ethylene and methacrylic acid, made with nominally 11 wt. % methacrylic acid (available from DuPont™)

Carrier Liquid:

Isopar L (available form EXXON): an isoparafinic oil.

Charge Adjuvant:

VCA (available from Sigma-Aldrich): an aluminium tristearate and palmitate salt.

Charge Director:

NCD: a natural charge director having the components (i) natural soya lecithin, (ii) basic barium petronate, and (iii) dodecyl benzene sulphonic acid, amine salt, with the components (i), (ii) and (iii) being present in the weight ratios of 6.6%:9.8:3.6%.

Pigments:

Yellow 30C236—CI Pigment Brown 24 (CAS #68186-90-3*, available from Glass Coatings & Concepts, LLC part of The Shepherd Material Science Company): a Chrome Antimony Titanium Buff Rutile pigment.

Magenta 307 (CAS #SC-CB, available from Glass Coatings & Concepts, LLC part of The Shepherd Material Science Company): a zirconium and iron oxide pigment.

Blue PB0189 (available from Glass Coatings & Concepts, LLC part of The Shepherd Material Science Company): a cobalt-silicon pigment.

Black PL0228 (available from Glass Coatings & Concepts, LLC part of The Shepherd Material Science Company): a black pigment based on Co—Cr—Fe—Mn.

White PW0319 (available from Glass Coatings & Concepts, LLC part of The Shepherd Material Science Company): R-900 rutile titanium dioxide pigment.

Glass Frits:

BX 80469 Clear (available from Glass Coatings & Concepts, LLC part of The Shepherd Material Science Company): glass oxide particulates, including zinc compounds.

SX80470 Clear, (CAS #65997-18-4; available from Glass Coatings & Concepts, LLC part of The Shepherd Material Science Company): glass oxide particulates, including zinc and bismuth compounds.

Transfer Film:

PET film Sarafil (12 μm thick), available from Polyflex

Primer Composition for Transfer Film:

An inline digital primer or transparent release composition was prepared by providing 73.14 g of a paste containing 35 wt. % of thermoplastic resin (Nucrel 699™ and A-C 5120™ in a ratio of 1:4 by weight), 35 wt. % maltosemonohydrate, 1.0 wt. % aluminium stearate (grinding aid material/charge adjuvant, available from Sigma Aldrich™) in Isopar L™ and grinding using a laboratory attritor (S0 from Union Process USA) at 25° C. for 24 hours. The composition was then diluted to 2 wt. % solids with Isopar L™ and charged by adding 8 mL of commercially available HP Indigo™ Imaging Agent (NCD) and left overnight.

General Grinding Procedure

Pigment was ground with resin and glass frit at a pigment loading level as indicated below in the presence of VCA (resin:VCA 39:1 w/w) at the indicated non-volatile solids (NVS) content in Isopar L in a S0 ceramic attritor (Union Process Attritors) with a mill size of 0.2 L) for 4 to 6 hours, or until the average diameter of the particles (D₅₀, as determined using a Malvern Mastersizer) is between 0.5 and 10 μm).

The ground material was then diluted with Isopar L to form working dispersions with the indicated NVS content.

TABLE 1

| | | | | Working |
|---|---|---|---|---|
| | | | Milling | Dispersion |
| Ink | Component | wt % | Conditions | (% NVS) |
| Yellow | Resin + VCA (40/1) | 40 | 35% NVS | 3% |
| | Pigment | 15 | 200 g | |
| | SX80470 Clear | 45 | 4 hours | |
| Red | Resin + VCA (40/1) | 50 | 50% NVS | 3% |
| | Pigment | 23 | 220 g | |
| | SX80470 Clear | 38 | 4 hours | |
| Blue | Resin + VCA (40/1) | 40 | 50% NVS | 3% |
| | Pigment | 18 | 220 g | |
| | SX80470 Clear | 42 | 4 hours | |
| Black | Resin + VCA (40/1) | 40 | 35% NVS | 3% |
| | Pigment | 15 | 200 g | |
| | SX80470 Clear | 45 | 4 hours | |
| White | Resin + VCA (40/1) | 40 | 50% NVS | 4% |
| | Pigment | 15 | 220 g | |
| | SX80470 Clear | 45 | 6 hours | |
| | | | cold milling | |

Printing Process

The working dispersions were found to be suitable for liquid electrophotographic printing processes and so a commercial HP Indigo printer was used to print a layer of primer onto the transfer material, and to reverse print images onto the primer layer using the ceramic inks from Table 1.

The image layer is then contacted with a glass or ceramic substrate under heat (150° C.) and pressure (2 bar) to transfer the image from the transfer material to the glass/ceramic substrate.

The glass/ceramic substrate bearing the image layer is then fired in an oven at 650° C. for 240 minutes. The firing step burns off any organic material and fuses the ceramic inks and glass frits to the glass/ceramic substrate.

Decorated glass/ceramic substrates prepared according to this process were found to have clear, vibrant images which were also as durable as the substrates themselves.

1. A liquid electrophotographic ink composition, comprising:
a ceramic pigment;
a polymer resin;
a glass frit; and
a liquid carrier.

2. The liquid electrophotographic ink composition according to claim 1, wherein the glass frit comprises glass particles comprising bismuth or zinc.

3. The liquid electrophotographic ink composition according to claim 1, wherein the ceramic pigment comprises particles of metal oxides, metal carbides or metal nitrides.

4. The liquid electrophotographic ink composition according to claim 1, wherein the ceramic pigment comprises copper chromite (III), iron-manganese oxide, iron-chromium-manganese-nickel oxide, a cobalt compound, a zirconium compound, a titanium compound, a zinc compound, an aluminium compound, a copper compound, a tin compound, or a bismuth compound, or mixtures thereof.

5. The liquid electrophotographic ink composition according to claim 1, wherein the polymer resin comprises a polymer having acidic side groups.

6. The liquid electrophotographic ink composition according to claim 1, wherein the ceramic pigment is present in the liquid electrophotographic ink composition in an amount of from 5 wt % to 45 wt % based on the total solids content of the ink.

7. The liquid electrophotographic ink composition according to claim 1, wherein the glass frit is present in the liquid electrophotographic ink composition in an amount of from 30 wt % to 50 wt, based on the total solids content of the ink.

8. A heat transferable printed image, comprising:
a transfer material; and
an electrophotographic ink composition disposed on the transfer material;
wherein the electrophotographic ink composition comprises:
a ceramic pigment;
a polymer resin; and
a glass frit.

9. The heat transferable printed image according to claim 8, wherein the transfer material comprises a polymer film of a plastic material selected from polyethylene (PE), linear low density polyethylene (LLDPE), low density polyethylene (LDPE), medium density polyethylene (MDPE), high density polyethylene (HDPE) polypropylene (PP), cast (cPP) or axially oriented polypropylene (BOPP), oriented polyamide (OPA), and polyethylene terephthalate (PET).

10. The heat transferable printed image according to claim 9, wherein the polymer film comprises a primer layer on which the electrophotographic ink composition is disposed.

11. A process for heat transfer printing, the process comprising:
electrophotographically printing a liquid electrophotographic ink composition onto a transfer material to form an image layer disposed on the transfer material, wherein the liquid electrophotographic ink composition comprises a ceramic pigment; polymer resin; a glass frit; and a liquid carrier, to form an image layer disposed on the transfer material;
contacting the image layer with a substrate under conditions such that the image layer transfers from the transfer material to the substrate; and
heating the substrate and the image layer to a temperature of at least 600° C.

12. The process according to claim 11, comprising:
electrophotographically printing a liquid electrophotographic ink
composition onto a primer layer disposed on the transfer material.

13. The process according to claim 11, wherein contacting the image layer with a substrate under conditions such that the image layer transfers from the transfer material to the substrate comprises applying heat and/or pressure.

14. The process according to claim 11, wherein the substrate and the image layer are heated to a temperature of at most 1250° C.

15. The process according to claim 11, wherein the substrate comprises a glass or ceramic substrate.
